(19) United States
(12) Patent Application Publication
(10) Pub. No.: US 2025/0307732 A1
(43) Pub. Date: Oct. 2, 2025

(54) GENERATION OF CAUSAL TEMPORAL GRAPHS FROM ANALYSIS REPORTS

(71) Applicant: Dell Products L.P., Round Rock, TX (US)

(72) Inventors: LEV MAKLER, Be'er Sheva (IL); OFIR EZRIELEV, Be'er Sheva (IL); ANAT PARUSH TZUR, Tel Aviv (IL); AMIHAI SAVIR, Newton, MA (US)

(21) Appl. No.: 18/622,010

(22) Filed: Mar. 29, 2024

(51) Int. Cl. G06Q 10/063; G06Q 10/04

(52) U.S. Cl. CPC G06Q 10/063; G06Q 10/04

(57) ABSTRACT

Methods and systems for managing generation of a causal temporal graph are disclosed. To manage generation of a causal temporal graph, an analysis report may be obtained including a time series prediction. The analysis report may then be binned into a set of binned predictions. For each of the binned predictions, at least one factor may be identified using the binned prediction, the analysis report, and a large language model, the at least one factor having a causal temporal relationship to the binned prediction. The causal temporal graph may be obtained indicating relationships between the factors and the binned predictions. Quantifications of the causal temporal relationship between the factors and the binned predictions may be selected to obtain weights for the relationships. The relationships and the weights may then be provided to a downstream consumer for use in interpreting the time series prediction.

### FIELD

Embodiments disclosed herein relate generally to graph generation. More particularly, embodiments disclosed herein relate to systems and methods to manage causal temporal graph generation from analysis reports.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIG. 3 shows a flow diagram illustrating methods of managing generation of a causal temporal graph in accordance with an embodiment.

FIGS. 4A-4B show diagrams illustrating example causal temporal graphs generated by the system in accordance with an embodiment.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing generation of a causal temporal graph for use in interpreting time series predictions generated by inference models. Time series predictions generated by inference models may be used as a basis for making decisions by a consumer of the predictions. For example, a time series prediction generated by an inference model may include a predicted demand for a product over a duration of time. The time series prediction may be provided to a business decision maker within a company in an analysis report to be used as a basis for determining a quantity of products to manufacture over the duration of time.

In order for the business decision maker to use the prediction in the analysis report to make decisions, the business decision maker may need to establish a level of confidence in the prediction. To establish a level of confidence, the business decision maker may wish to understand which portions of the ingest data used by the inference model had an impact on generation of the predictions.

While the analysis report may include information regarding correlations between ingest data and the time series prediction, the business decision maker may wish to understand causal relationships between the ingest data and the prediction. In addition, the business decision maker may wish to understand how ingest data affected different portions of the prediction over the duration of time. To do so, a causal temporal graph may be provided to the business decision maker, the causal temporal graph indicating causal temporal relationships between the ingest data and portions of the prediction.

To generate the causal temporal graph, a large language model (LLM) may be used to parse the analysis report to determine portions of the ingest data (e.g., factors) which impacted portions of the prediction (e.g., binned predictions). A degree of impact of each of the factors on each of the binned predictions may be quantified by assigning weights to the relationships between the factors and the binned predictions. The weights may then be used to rank the factors, and the factors and the ranking may then be provided to the business decision maker in a causality report to establish a level of confidence in the prediction and assist in interpreting the prediction.

Thus, embodiments disclosed herein may address, among other technical problems, the technical challenge of interpreting predictions generated by inference models. By using an analysis report to generate a causality report including a causal temporal graph and a ranking of factors which impacted the predictions, causal temporal relationships between predictions and factors can be visualized and quantified. Providing the causality report to a consumer of the predictions may result in an increased likelihood that the consumer will ascribe the appropriate level of confidence to the predictions and may assist the consumer in making decisions based on the predictions.

In an embodiment, a method for managing generation of a causal temporal graph is disclosed. The method may include: obtaining an analysis report, the analysis report including a time series prediction over a duration of time; obtaining, based on the analysis report, prediction bins, each of the prediction bins indicating a portion of the duration of time; obtaining, using the analysis report and the prediction bins, a set of binned predictions, each binned prediction of the set of binned predictions including one or more predictions of the time series prediction; for each binned prediction of the binned predictions, identifying at least one factor, using the binned prediction, the analysis report, and a large language model (LLM), which has a causal temporal relationship to the binned prediction; obtaining, using the set of binned predictions and the at least one factor for each of the binned predictions, the causal temporal graph, the causal temporal graph indicating relationships between the factors and the binned predictions of the set of binned predictions; selecting, using at least the causal temporal graph and values for the binned predictions, quantifications of the causal temporal relationship between the factor and the binned prediction to obtain weights for the relationships; and providing the relationships and the weights between the factors and the binned predictions to a downstream consumer for use in interpreting the time series prediction.

The analysis report may include a set of predictions indicating a condition impacting a business over the duration of time.

The condition impacting the business over the duration of time may include a change in the demand of a product by consumers.

Identifying the factors may include: providing the analysis report and the binned predictions as ingest data for the LLM; and obtaining, as an output from the LLM, the factors and a set of causal relationships.

The set of causal relationships may include: a first causal relationship, the first causal relationship indicating that a first factor of the factors impacted generation of at least a first prediction of the set of predictions by the inference model.

The factors may include at least one factor selected from a list of factors including: consumer spending; supply data; demand data; and supply chain data.

The causal temporal graph may include: a set of prediction nodes, each prediction node of the set of prediction nodes representing a binned prediction and ordered with respect to the duration of time; a set of factor nodes, each factor node representing a factor that has a causal relationship with a binned prediction and ordered with respect to the duration of time; and a set of edges.

A first portion of the set of edges may represent connections from factor nodes to the prediction nodes, a second portion of the set of edges may represent connections between the factor nodes, and a third portion of the set of edges may represent connections between the prediction nodes.

Selecting quantifications of the causal temporal relationship between the factor and the binned prediction to obtain weights for the relationships may include performing a global optimization of weights for each edge of the set of edges.

The relationships and the weights between factors and binned predictions may be provided to the downstream consumer in a report that ranks the quantitative impact of each factor on each binned prediction.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

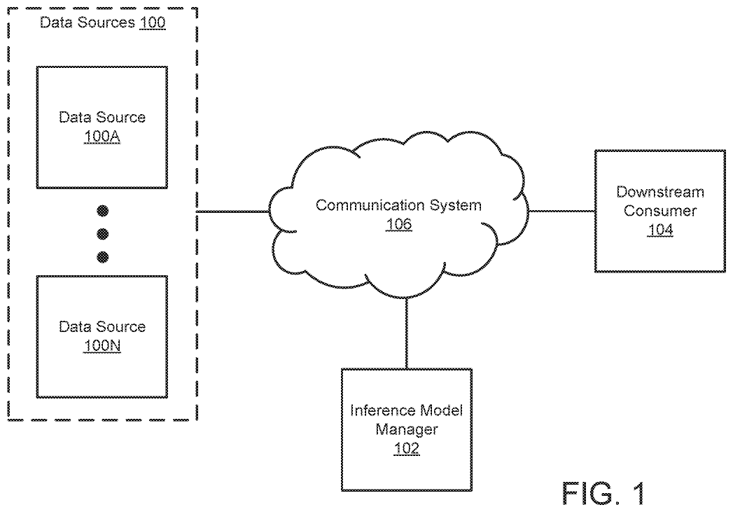

Turning to FIG. 1, a block diagram illustrating a system in accordance with an embodiment is shown. The system shown in FIG. 1 may provide computer-implemented services utilizing data obtained from any number of data sources and stored in a data repository prior to performing the computer-implemented services. The computer-implemented services may include any type and quantity of computer-implemented services. For example, the computer-implemented services may include prediction generation services, prediction analysis services, and/or any other type of computer-implemented services.

To provide the computer-implemented services, the system may include data sources 100. Data sources 100 may include any number of data sources. For example, data sources 100 may include one data source (e.g., data source 100A) or multiple data sources (e.g., 100A-100N). Each data source of data sources 100 may include hardware and/or software components configured to obtain data, store data, provide data to other entities, and/or to perform any other task to facilitate performance of the computer-implemented services.

All, or a portion, of data sources 100 may provide (and/or participate in and/or support the) computer-implemented services to various computing devices operably connected to data sources 100. Different data sources may provide similar and/or different computer-implemented services.

For example, data sources 100 may store demand data indicating historic demand for a product. Data sources 100 may provide the data (e.g., the demand data) to inference model manager 102. Inference model manager 102 may use the data obtained from data sources 100 to make predictions regarding future demand for the product (e.g., a demand prediction) over a duration of time (e.g., a time series prediction). Inference model manager 102 may use the demand prediction to generate an analysis report.

Inference model manager 102 may provide the analysis report to downstream consumer 104. A user of downstream consumer 104 may be a business decision maker within a company tasked with making decisions based on the analysis report. For example, a business decision maker may use the demand prediction to determine a quantity of products to be manufactured by the company over a duration of time (e.g., the following year).

In order for the user of downstream consumer 104 to utilize the analysis report provided by inference model manager 102 to make decisions, the user of downstream consumer 104 may need to understand what data (e.g., inference model ingest data) the predictions in the analysis report are based on. For example, the business decision maker in the company may wish to understand what portions of the inference model ingest data were used to generate the demand prediction prior to making decisions based on the demand prediction.

To attempt to understand what portions of the inference model ingest data were used to generate predictions included in the analysis report, a user of downstream consumers 104 may manually evaluate and/or analyze the inference model ingest data. While manually evaluating and/or analyzing the inference model ingest data, the user may use resources inefficiently, the resources including (i) the user's time, (ii) the user's cognitive resources, (iii) computing resources consumed while the user manually evaluates and/or analyzes the data using a computer, and/or (iv) other resources.

Additionally, because the user may make qualitative assessments during the process of evaluating and/or analyzing the inference model ingest data and may manually input information into a computer reflective of the qualitative assessments, the user may make an error. The error may include (i) incorrectly identifying causal relationships between the data and the predictions, (ii) incorrectly interpreting the data and/or predictions, (iii) incorrectly inputting the information into the computer, and/or (iv) other errors. As a result of the error, the user may be unable to understand what portions of the inference model ingest data were used to generate the predictions included in the analysis report. In addition, the user may be unable to identify all of the relationships between the portions of the inference model ingest data and the predictions, resulting in an incomplete understanding of how different portions of the inference model ingest data impacted generation of the predictions.

Therefore, computer-implemented services provided based on the analysis report may be impacted, which may result in (i) a delay in providing the services, (ii) a reduction in quality of the services, and/or (iii) other negative impacts on the services.

In general, embodiments disclosed herein may provide methods, systems, and/or devices for managing generation of a causal temporal graph for use in interpreting a time series prediction. To manage generation of a causal temporal graph, the system may obtain an analysis report. The analysis report may include a time series prediction over a duration of time.

Each prediction included in the analysis report may be binned (e.g., according to portions of the duration of time over which the predictions were obtained) to obtain a set of binned predictions. The set of binned predictions and the analysis report may be ingested by a first LLM and factors may be obtained as an output from the first LLM. The obtained factor(s) may include portions of data that have a causal relationship to the binned predictions.

Using the factors and the binned predictions, a causal temporal graph may be obtained. The causal temporal graph may indicate relationships between the factors and the binned predictions. The relationships may then be quantified to obtain weights, the weights indicating a degree to which each factor impacted each binned prediction. The relationships (and the quantifications of the relationships) between the factors and the binned predictions may then be provided to a downstream consumer to assist in interpreting the time series prediction.

By doing so, a system in accordance with an embodiment may increase the likelihood of generating predictions using inference models that are explainable to a downstream consumer of the predictions. As a result, the downstream consumer may more efficiently establish a level of confidence in the predictions thereby conserving resources (e.g., computing resources, time resources) of the downstream consumer. By doing so, resources may be allocated to providing computer-implemented services based on the predictions which may increase a reliability and/or quality of the services.

To perform the above-noted functionality, the system of FIG. 1 may include data sources 100, inference model manager 102, and/or downstream consumer 104. Each of these components is discussed below.

Data sources 100 may include data from any number of sources (e.g., data sources 100A-100N), and may provide data to inference model manager 102. Data provided to inference model manager 102 by data sources 100 may include training data usable to train inference models managed by inference model manager 102 and/or input data usable as ingest for inference models managed by inference model manager 102.

Inference model manager 102 may include any number and/or type of data processing systems. The data processing systems may train and/or host any number and/or type of inference models trained to generate inferences (e.g., predictions).

Inference model manager 102 may provide inference model management services. To provide the inference model management services, inference model manager 102 may obtain data (e.g., from data sources 100), process the data (e.g., fill data gaps, transform the data, extract values from the data), use training data to train any number of inference models, generate predictions (e.g. using the data as input for the inference models), analyze the predictions (e.g., make comparisons between predictions) and/or may provide the predictions to other entities (e.g., downstream consumer 104) as part of facilitating the computer-implemented services.

For example, inference model manager 102 may host a first inference model which may use data obtained from data sources 100 to generate predictions regarding the demand for a product over a duration of time (e.g., a time series prediction). Inference model manager 102 may also host an LLM, which may use (i) data obtained from data sources 100, (ii) predictions generated by an inference model, (iii) text regarding predictions generated by an inference model, and/or (iv) other types of data as ingest to generate human readable text.

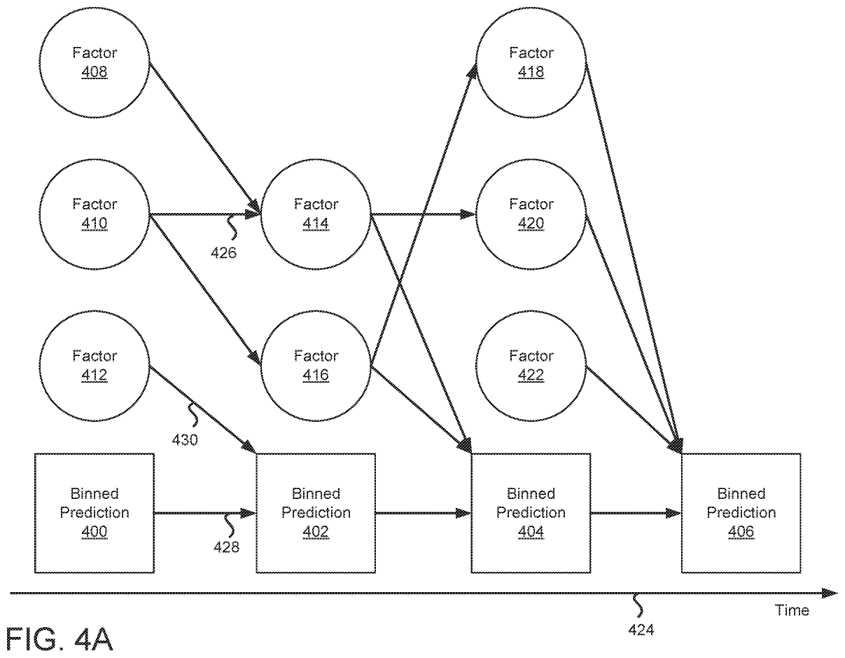

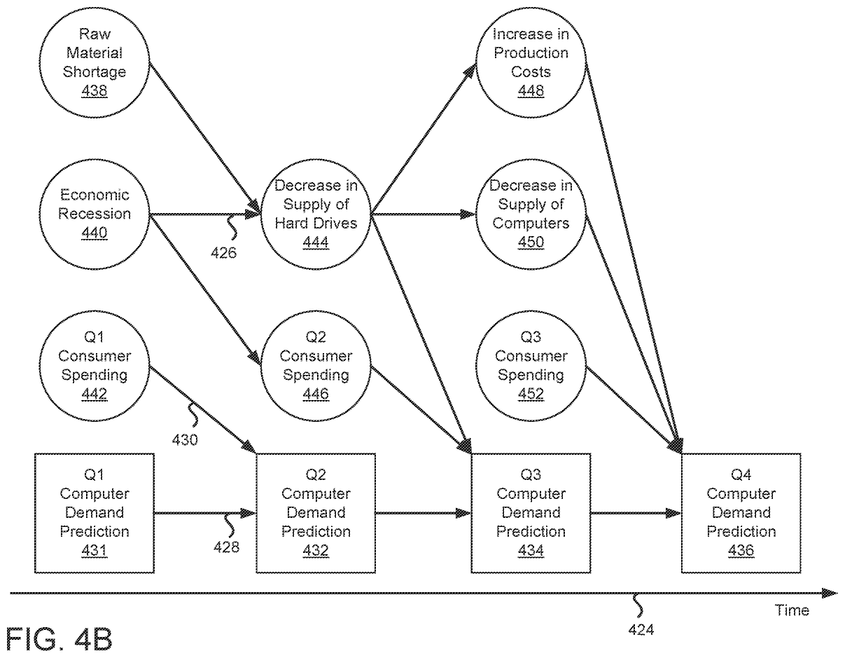

In addition, inference model manager 102 may generate, train and/or store any number of causal temporal graphs based on: (i) data provided by data sources 100, (ii) predictions generated by inference models, (iii) human readable text generated by LLMs, and/or (iv) other data. Refer to FIGS. 4A-4B for an example causal temporal graph.

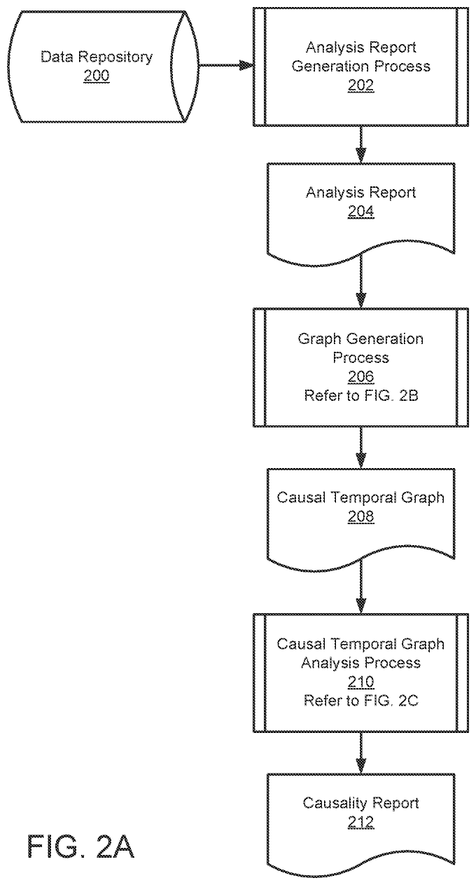

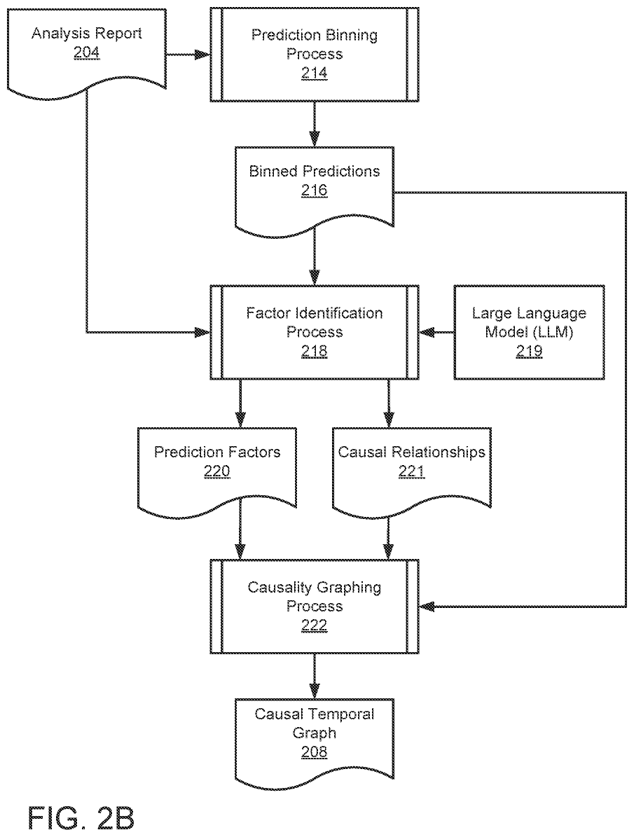

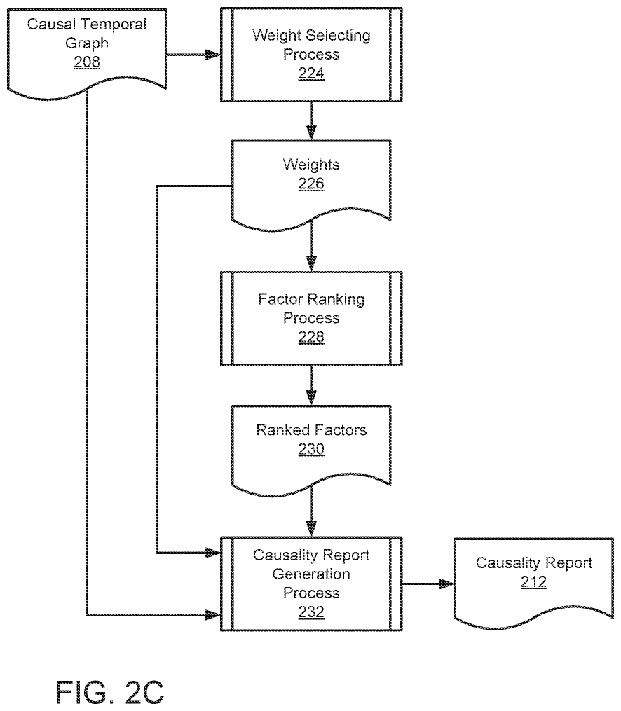

To generate a causal temporal graph, the LLM hosted by inference model manager 102 may be used to analyze the analysis report. During analysis report analysis, the LLM may be used to identify: (i) factors that impacted generation of the predictions in the analysis report, (ii) causal relationships between predictions and types of data (e.g., the factors), (iii) causal relationships between the factors, and/or (iv) other types of information. Refer to FIG. 2B for additional details regarding factor identification processes.

The causal relationships may then be used to generate a causal temporal graph, indicating the causal relationships over time. The relationships may be assigned weights indicating the degree to which the factor influenced the prediction and/or other factors. The weights may be used to rank the factors based on their degree of influence, and the ranking may be used to generate a causality report describing the relationships and the ranking. Refer to FIG. 2C for additional details regarding weighting factors and generating the causality report.

The causality report may then be provided to downstream consumer 104. Downstream consumer 104 may include any number and/or type of downstream consumers which may use predictions generated by inference model manager 102 to provide computer-implemented services. A user of downstream consumer 104 may use the causality report to interpret the time series prediction regarding the demand for a product over a duration of time. The causality report may assist the user in understanding how the inference model generated the predictions and which data was most influential on the predictions, which may allow the user to decide whether to trust the generated predictions to use as a basis for making decisions (e.g., business decisions).

By automating generation of a quantitative report based on predictions generated by an inference model, the computer-implemented services provided by downstream consumer 104 may be less likely to be delayed and more likely to be of a high quality than if the user manually interpreted the predictions.

When providing their functionality, any of data sources 100, inference model manager 102, and downstream consumer 104 may perform all, or a portion, of the processes, interactions, and methods illustrated in FIGS. 2A-4B.

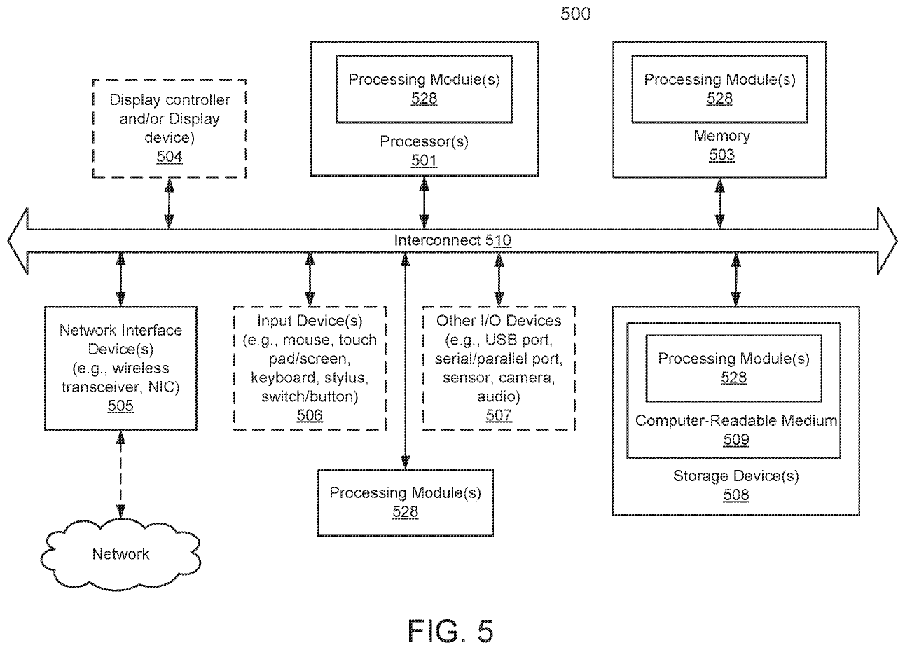

Any of data sources 100, inference model manager 102, and downstream consumer 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), and edge device, an embedded system, local controllers, an edge node, and/or any other type of data processing device or system. For additional details regarding computing devices, refer to FIG. 5.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 204, 208, etc.) is used to represent data structures, a second set of shapes (e.g., 202, 206, etc.) is used to represent processes performed using and/or that generate data, and a third set of shapes (e.g., 200, etc.) is used to represent large scale data structures such as databases.

Turning to FIG. 2A, a first data flow diagram in accordance with an embodiment is shown. The first data flow diagram may illustrate data used in and data processing performed in generating causality report 212.

To generate causality report 212, analysis report generation process 202 may be performed using data from data repository 200. Data repository 200 may include data from any number of data sources, and may include, for example, demand data regarding demand for a product. The demand data may include (i) historical data regarding demand for the product, (ii) historical data regarding consumer spending, (iii) forecasted data regarding market trends (e.g., which may impact demand for the product), (iv) data regarding the consumer, (v) data regarding product supply (e.g., which may impact demand for the product) and/or (vi) other demand data.

Analysis report generation process 202 may include: (i) obtaining data from data repository 200, (ii) feeding the data into an inference model as ingest data, (iii) obtaining a set of predictions as outputs from the inference model, and/or (iv) compiling the any number of predictions and/or other data to generate analysis report 204. The inference model may be trained to generate predictions indicating a condition impacting a business over a duration of time. For example, the condition impacting the business over the duration of time may include a change in the demand of a product by consumers.

Analysis report 204 may include the demand data used by the inference model to generate the set of predictions regarding product demand, the set of predictions regarding product demand, and/or text describing the set of predictions regarding product demand in human-readable language. The text describing the set of predictions may include, for example, labels provided by a subject matter expert (SME) indicating potential causal relationships between the input data for the inference model and the set of predictions and/or other information.

For example, the business may be a company that sells computers. In order to determine the quantity of computers to manufacture over a duration of time, the company may obtain demand data regarding demand for computers by consumers. The demand data may be used as ingest for an inference model to generate a set of predictions regarding computer demand over the duration of time. A report may be generated including the demand data, the set of predictions, and text describing the set of predictions.

Analysis report 204 may then be used to perform graph generation process 206. During graph generation process 206, the set of the predictions may be binned to obtain binned predictions. The binned predictions (not shown) and analysis report 204 may be fed into a first LLM to identify factors which impacted the binned predictions (e.g., factors which have a causal relationship to the binned predictions). Using the factors and the binned predictions, causal temporal graph 208 may be generated. Causal temporal graph 208 may include: (i) nodes representing binned predictions and factors, and (ii) edges between the nodes to represent causal relationships. Refer to FIG. 2B for additional details regarding graph generation process 206. Refer to FIGS. 4A-4B for visual examples of causal temporal graphs.

Causal temporal graph 208 may then be used to perform causal temporal graph analysis process 210. During causal temporal graph analysis process 210, the identified causal relationships may be quantified using a weighting process. The weights may then be ranked based on a degree of impact on each of the binned predictions. Using the rankings, the causal temporal graph, and/or the causal relationships causality report 212 may then be generated. Causality report 212 may include a human-readable report generated by an LLM which may be used by a downstream consumer to interpret the analysis report. Refer to FIG. 2C for additional details regarding causal temporal graph analysis process 210.

Thus, by implementing the data flow shown in FIG. 2A, a system in accordance with embodiments disclosed herein may provide insights usable to establish a level of confidence in predictions generated by an inference model. By generating a causality report, a downstream consumer may have an increased likelihood ascribing an appropriate level of confidence to the predictions, which may assist the downstream consumer in making decisions based on the predictions.

Turning to FIG. 2B, a second data flow diagram in accordance with an embodiment is shown. The second data flow diagram may illustrate data used in and data processing performed in generating causal temporal graph 208 using analysis report 204. FIG. 2B may be an expansion of graph generation process 206 shown in FIG. 2A.

To generate causal temporal graph 208, analysis report 204 may be used to perform prediction binning process 214. To perform prediction binning process 214, prediction bins may be selected using the time series prediction over a duration of time indicated in analysis report 204, each of the prediction bins indicating a portion of the duration of time. Using the prediction bins and analysis report 204, a set of binned predictions (e.g., binned predictions 216) may be obtained, each binned prediction of the set of binned predictions including one or more predictions of the time series prediction.

For example, a company that sells computers may need to determine the quantity of computers to manufacture in each quarter over the next year (e.g., four quarters per year). To make the determination, the company may obtain an analysis report which includes a time series prediction of computer demand over the next year. The time series prediction may include 100 data points spread evenly over the year, each data point indicating predicted computer demand at a point in time.

In order for the company to use the analysis report to determine demand in each quarter, the time series prediction may be binned into four bins, one bin for each quarter. To bin the prediction, the data may be grouped into four sets containing 25 data points in chronological order. The predicted demand indicated in each of the 25 data points of the bin may then be aggregated into one value representing total demand prediction for each quarter.

Factor identification process 218 may then be performed. During factor identification process 218, at least one factor may be identified for each binned prediction which has a causal temporal relationship to the binned prediction. The factors (e.g., prediction factors 220) may be identified using binned predictions 216, the analysis report, and LLM 219. LLM 219 may be a language model (e.g., an artificial neural network) trained to generate language, understand language, and/or otherwise process requests related to languages. The factors may include: (i) consumer spending (e.g., historical data regarding consumer spending, forecasted data regarding trends in consumer spending), (ii) supply data (e.g., historical data regarding market availability of the product from any number of suppliers, historical data regarding supply of the product from a supplier, forecasted data regarding supply of the product), (iii) demand data (e.g., historical data regarding demand for the product, data regarding the consumer), (iv) supply chain data (e.g., data regarding raw material availability, data regarding product/raw material transport), and/or (v) other factors.

Factor identification process 218 may include providing the analysis report and binned predictions 216 as ingest for LLM 219, and obtaining, as output from LLM 219, prediction factors 220 and a set of causal relationships (e.g., causal relationships 221). To do so, LLM 219 may parse text included in analysis report 204 to identify indications of any potentially causal relationships between portions of the ingest data for the inference model and the predictions. Causal relationships 221 may include a first causal relationship, the first causal relationship indicating that a first factor of the factors impacted generation of at least a first prediction of the set of predictions by the inference model. Causal relationships 221 may include any number of additional causal relationships without departing from embodiments disclosed herein.

For example, the binned predictions representing demand for computers for four quarters over the next year (e.g., binned predictions 216) and the analysis report (e.g., analysis report 204) may be provided to LLM 219. LLM 219 may use the analysis report and the binned predictions to obtain a list of factors for each binned prediction (e.g., prediction factors 220) and a set of causal relationships between the factors and each binned prediction (e.g., causal relationships 221). Each factor may represent data (e.g., a portion of inference model ingest data) which impacted the binned prediction and each causal relationship may indicate a likely causal relationship between the factor and the binned prediction.

For example, the LLM may identify that the demand prediction for computers in the second quarter may have a causal relationship with data regarding consumer spending in the first quarter, data regarding supply of the product from a supplier (e.g., a competitor which sells computers similar to the computers sold by the company may be closing), and data regarding raw material transport (e.g., a waterway used to transport a material used by the company to build the computers may be closing).

Prediction factors 220 and binned predictions 216 may then be used to perform causality graphing process 222. During causality graphing process 222, causal temporal graph 208 may be generated, indicating the relationships between the factors and the binned predictions. Causal temporal graph 208 may include (i) a set of prediction nodes obtained from the analysis report, each prediction node of the set of prediction nodes representing a binned prediction and ordered with respect to the duration of time, (ii) a set of factor nodes obtained from the analysis report, each factor node representing a factor that has a causal relationship with a binned prediction and ordered with respect to the duration of time, and/or (iii) a set of edges obtained from the analysis report. A first portion of the set of edges may represent connections from factor nodes to the prediction nodes, a second portion of the set of edges may represent connections between the factor nodes, and a third portion of the set of edges may represent connections between the prediction nodes. Refer to FIGS. 4A-4B for example causal temporal graphs.

For example, the four binned predictions indicating computer demand for each of four quarters and the factors which were identified as having a causal temporal relationship to the binned predictions may be used to generate a causal temporal graph. The causal temporal graph may include a set of four prediction nodes (e.g., one prediction node per binned prediction), a set of factor nodes (e.g., one node representing each factor which impacted a binned prediction), and a set of edges (e.g., arrows connecting a first node to a second node, the arrow directed from the first node to the second node on which it had an impact).

Thus, by implementing the data flow shown in FIG. 2B, a system in accordance with embodiments disclosed herein may be used to generate a causal temporal graph, which may increase the likelihood of identifying which data impacted predictions generated by an inference model.

Turning to FIG. 2C, a third data flow diagram in accordance with an embodiment is shown. The third data flow diagram may illustrate data used in and data processing performed in generating causality report 212 from causal temporal graph 208. FIG. 2C may be an expansion of causal temporal graph analysis process 210 shown in FIG. 2A.

To generate causality report 212, weight selecting process 224 may be performed using at least causal temporal graph 208 and values for each node of causal temporal graph 208 (e.g., the prediction nodes, the factor nodes). During weight selecting process 224, quantifications of the causal temporal relationship between the factors and the binned predictions may be selected to obtain weights for the relationships (e.g., weights 226). Weight selecting process 224 may include performing a global optimization of weights for each edge of the set of edges in the causal temporal graph.

For example, the company that sells computers may need information regarding the degree to which each factor impacted each of the four binned predictions in order to assist in interpreting the predictions. To quantify the degree of impact of each of the factors on each of the predictions, weights may be selected for each edge on the causal temporal graph connecting a factor node to a prediction node. To obtain the weights, the causal temporal graph may be trained and/or populated based on analysis of the analysis report. For example, the analysis report may be analyzed to identify strengths of claims regarding causality and the weights may be set based on quantification analysis of those strengths. In another example, a global optimization process may be performed using values of the factor nodes and values of the prediction nodes to obtain the weights.

Causal temporal graph 208 may be trained at different time points with respect to time (e.g., after the first quarter, after the third quarter) in order to assign weights to each factor of each of the prediction bins.

Using weights 226, factor ranking process 228 may be performed to obtain ranked factors 230. During factor ranking process 228, the factors may be ordered from most impactful (e.g., the factor assigned the highest weight) to least impactful (e.g., the factor assigned the lowest weight).

For example, weights may be assigned to each of three factors identified as impacting the second quarter prediction for computer demand. The weights may be represented as values between 0 and 1, a higher value indicating a stronger causal relationship. The weights may include: 0.1 for data regarding consumer spending in the first quarter, 0.5 for data regarding supply of the product from a supplier, and 0.4 for data regarding raw material transport. The weights may then be used to rank the factors from most impactful to least impactful, which may result in an ordered list of factors including: data regarding supply of the product from a supplier, data regarding raw material transport, and data regarding consumer spending in the first quarter. Weights 226 may be obtained via other methods and/or assigned according to other scales without departing from embodiments disclosed herein.

Ranked factors 230, weights 226, and/or causal temporal graph 208 may then be used to perform causality report generation process 232. During causality report generation process 232, an LLM may be used to generate a human-readable report (e.g., causality report 212). The report may include text describing (i) the relationships between the factors and the binned predictions, (ii) the weights quantifying the relationships, (iii) the ranking of the quantitative impact of each factor on each binned prediction and/or (iv) other information. The report may then be provided to a downstream consumer for use in interpreting the time series prediction.

For example, causality report 212 may include a ranking of the three factors identified as impacting the second quarter prediction for computer demand. Causality report 212 may be provided to a business decision maker within the company tasked with deciding the quantity of computers to manufacture each quarter. The business decision maker may use the report to understand what factors impacted the second quarter demand prediction and the degree of impact of each of the factors. The business decision maker may utilize the information included in causality report 212 to establish a level of confidence in the second quarter prediction for computer demand. The business decision maker may use the level of confidence as a basis for determining the quantity of computers to manufacture in the second quarter.

Thus, via the processes illustrated in FIG. 2C, a system in accordance with an embodiment may generate a causality report ranking the factors that were identified as impacting the binned predictions. By weighting and ranking the factors, quantitative and qualitative information regarding the degree of impact of each factor on each prediction may be provided to a downstream consumer, which may increase the likelihood of the downstream consumer understanding and trusting the predictions generated by the inference model.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

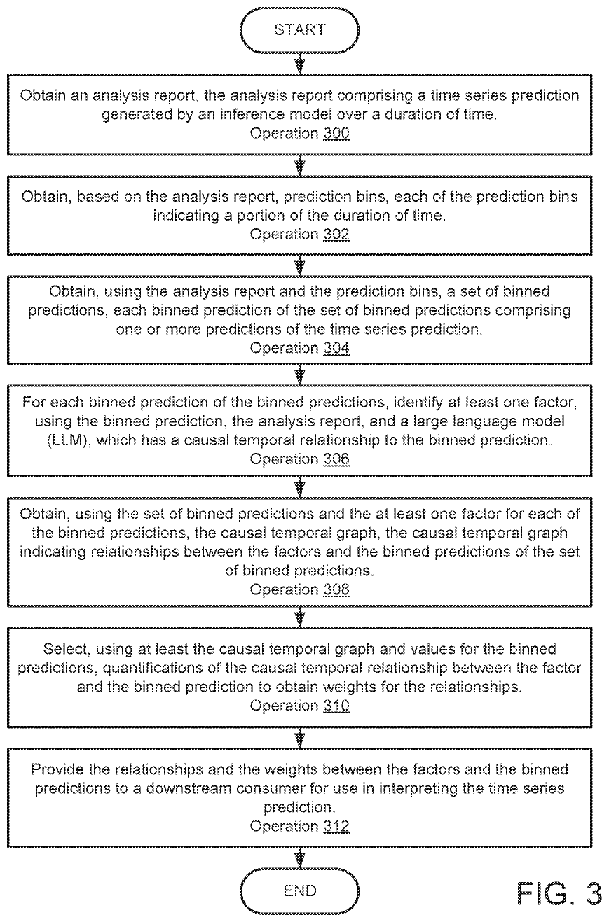

As discussed above, the components of FIGS. 1-2C may perform various methods to manage generation of a causal temporal graph. FIG. 3 illustrates a method that may be performed by the components of the system of FIGS. 1-2C. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing generation of a causal temporal graph in accordance with an embodiment is shown. The method may be performed, for example, by any of the components of the system of FIG. 1, and/or any other entity without departing from embodiments disclosed herein.

At operation 300 an analysis report may be obtained. The analysis report may include a time series prediction over a duration of time. Obtaining the analysis report may include (i) reading the analysis report from storage, (ii) generating the analysis report based on predictions obtained from an inference model, (iii) receiving the analysis report from another device, and/or (iv) other methods.

At operation 302 prediction bins may be obtained based on the analysis report. Each of the prediction bins may indicate a portion of the duration of time. Obtaining the prediction bins may include (i) generating the prediction bins by dividing the duration of time into portions, (ii) receiving the prediction bins from another device, and/or (iii) other methods.

At operation 304 a set of binned predictions may be obtained using the analysis report and the prediction bins. Each binned prediction of the set of binned predictions may include one or more predictions of the time series prediction. Obtaining the set of binned predictions may include (i) dividing the data in the time series prediction into a number of portions indicated by the prediction bins, (ii) aggregating the data within each of the portions to obtain binned predictions, (iii) providing the analysis report and the prediction bins to another device responsible for binning the predictions and receiving the set of binned predictions in response, and/or (iv) other methods.

At operation 306 at least one factor may be identified for each binned prediction of the binned predictions using the binned prediction, the analysis report, and an LLM. The at least one factor may have a causal temporal relationship to the binned prediction. Identifying at least one factor may include (i) providing the analysis report and the binned predictions as ingest data for the LLM (e.g., obtaining the LLM, inputting the analysis report and the binned predictions into the LLM), (ii) obtaining, as output from the LLM, the factors and a set of causal relationships (e.g., generating a report using the LLM indicating the factors and a set of causal relationships, receiving the factors and a set of causal relationships from another device which hosts the LLM), and/or (iii) other methods.

At operation 308 the causal temporal graph may be obtained using the set of binned predictions and the at least one factor for each of the binned predictions. The causal temporal graph may indicate relationships between the factors and the binned predictions of the set of binned predictions. Obtaining the causal temporal graph may include (i) generating the causal temporal graph based on the set of binned predictions and the at least one factor for each of the binned predictions, (ii) providing the set of binned predictions and the at least one factor for each of the binned predictions to another device responsible for generating the causal temporal graph and receiving the causal temporal graph in response, and/or (iii) other methods.

Generating the causal temporal graph may include (i) obtaining a rule set for causal temporal graph generation, the rule set indicating that binned predictions and factors are to be represented as nodes on the graph connected by edges indicating a causal relationship between the nodes and oriented with respect to time, (ii) parsing the rule set for causal temporal graph generation, (iii) obtaining the causal temporal graph based on the rule set for causal temporal graph generation, and/or (iv) other methods.

At operation 310, quantifications of the causal temporal relationship between the factor and the binned prediction may be selected to obtain weights for the relationships. Selecting quantifications of the causal temporal relationship between the factor and the binned prediction may include (i) performing a global optimization of weights for each edge of the set of edges, (ii) providing the causal temporal graph to another device responsible for quantifying the relationship between the factor and the binned prediction, and/or (iii) other methods.

Performing a global optimization of weights for each edge of the set of edges may include (i) generating the weights using the causal temporal graph and the data from the analysis report, (ii) providing the causal temporal graph and the analysis report to another device responsible for performing a global optimization of weights and receiving the weights in response, and/or (iii) other methods.

At operation 312 the relationships and the weights between the factors and the binned predictions may be provided to a downstream consumer for use in interpreting the time series prediction. Providing the relationships and the weights between the factors and the binned predictions to a downstream consumer may include (i) generating a report that ranks the quantitative impact of each factor on each binned prediction and providing the report to the downstream consumer as a message over a communication system, (ii) storing the relationships and the weights between the factors and the binned prediction in storage which can be accessed by the downstream consumer, and/or (iii) other methods.

Generating a report that ranks the quantitative impact of each factor on each binned prediction may include (i) obtaining the weights assigned to each factor, (ii) ordering the factors based on the weights, (iii) encapsulating the ordering of the factors and/or other data into a report (e.g., a data structure) and/or (iv) other methods.

The method may end following operation 312.

Thus, using the methods illustrated in FIG. 3, embodiments disclosed herein may provide systems and methods usable to manage generation of a causal temporal graph to be used to assist in interpreting a time series prediction generated by an inference model.

To further clarify embodiments disclosed herein, an example implementation in accordance with an embodiment is shown in FIGS. 4A-4B. These figures show diagrams illustrating a causal temporal graph in accordance with an embodiment.

Turning to FIG. 4A, an example causal temporal graph is shown. The causal temporal graph may include prediction nodes 400-406. Prediction nodes 400-406 may represent binned predictions, each binned prediction indicating a portion of a time series prediction. While shown as including four prediction nodes, the causal temporal graph may include more, less, and/or different prediction nodes than those described with respect to FIG. 4A. Relationships between the prediction nodes may be represented by edges connecting prediction nodes (e.g., 428). Edges between prediction nodes may be represented with arrows, the directionality of the arrows indicating a temporal ordering of the binned predictions with respect to a time axis (e.g., 424).

The causal temporal graph may also include factor nodes 408-422. Factor nodes 408-422 may represent the factors identified by an LLM as potentially causally related to the binned predictions. While shown as including eight factor nodes, the causal temporal graph may include more, less, and/or different factor nodes than those described with respect to FIG. 4A. The factor nodes may be arranged vertically with respect to a binned prediction, indicating a temporal relationship with the binned prediction (e.g., binned prediction 400 and factor 408). Each factor node may have a causal relationship to a binned prediction and/or another factor node.

Causal relationships may be represented as edges between factor nodes and binned predictions (e.g., 430) and/or as edges between factor nodes (e.g., 426). Edges between factor nodes and binned predictions and/or edges between factor nodes may be represented with arrows, the directionality of the arrows indicating the direction of causality (e.g., the arrow points toward the node on which the other node has an impact).

Turning to FIG. 4B, an example causal temporal graph representing quarterly demand predictions for computers by consumers is shown. The causal temporal graph may include prediction nodes 431-436. Prediction nodes 431-436 may represent quarterly demand predictions obtained by binning a time series prediction of computer demand over one year into four quarters (e.g., Q1 computer demand prediction 431 may include a quantification of a binned computer demand prediction for the first quarter). Edges between prediction nodes (e.g., 428) may represent the temporal ordering of the binned predictions with respect to the time axis (e.g., 424) (e.g., the first quarter computer demand prediction is ordered earlier than the second quarter computer demand prediction with respect to time).

The causal temporal graph representing quarterly demand predictions for computers by consumers may also include factor nodes 438-452. During the factor identification process, eight factors may be identified as including data which impacted the numerical values of the binned predictions. The factors may be arranged vertically with respect to a quarterly prediction indicating a temporal relationship with the quarterly prediction (e.g., Q1 consumer spending 442 may be oriented above Q1 computer demand prediction 431 to indicate the consumer spending data represents consumer spending in the first quarter).

Edges between factor nodes and binned predictions (e.g., 430) may represent a causal relationship, indicating the factor had an impact on the binned prediction. For example, Q1 consumer spending 442 is connected to Q2 computer demand prediction 432 via edge 430, indicating the consumer spending data from the first quarter impacted the prediction quantity regarding computer demand in the second quarter. Edges between factor nodes (e.g., 426) may represent a causal relationship, indicating the first factor had an impact on the second factor. For example, economic recession 440 is connected to decrease in supply of hard drives 444 via edge 426, indicating the economic recession in the first quarter impacted the supply of hard drives in the second quarter.

Any of the components illustrated in FIGS. 1-4B may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing generation of a causal temporal graph, the method comprising:
obtaining an analysis report, the analysis report comprising a time series prediction over a duration of time;
obtaining, based on the analysis report, prediction bins, each of the prediction bins indicating a portion of the duration of time;
obtaining, using the analysis report and the prediction bins, a set of binned predictions, each binned prediction of the set of binned predictions comprising one or more predictions of the time series prediction;
for each binned prediction of the binned predictions, identifying at least one factor, using the binned prediction, the analysis report, and a large language model (LLM), which has a causal temporal relationship to the binned prediction;
obtaining, using the set of binned predictions and the at least one factor for each of the binned predictions, the causal temporal graph, the causal temporal graph indicating relationships between the factors and the binned predictions of the set of binned predictions;
selecting, using at least the causal temporal graph and values for the binned predictions, quantifications of the causal temporal relationship between the factor and the binned prediction to obtain weights for the relationships; and
providing the relationships and the weights between the factors and the binned predictions to a downstream consumer for use in interpreting the time series prediction.

2. The method of claim 1, wherein the analysis report comprises a set of predictions indicating a condition impacting a business over the duration of time.

3. The method of claim 2, wherein the condition impacting the business over the duration of time is a change in demand of a product by consumers.

4. The method of claim 2, wherein identifying the factors comprises:
providing the analysis report and the binned predictions as ingest data for the LLM; and
obtaining, as an output from the LLM, the factors and a set of causal relationships.

5. The method of claim 4, wherein the set of causal relationships comprises:
a first causal relationship, the first causal relationship indicating that a first factor of the factors impacted generation of at least a first prediction of the set of predictions by an inference model.

6. The method of claim 1, wherein the factors comprise at least one factor selected from a list of factors consisting of:
consumer spending;
supply data;
demand data; and
supply chain data.

7. The method of claim 1, wherein the causal temporal graph comprises:
a set of prediction nodes, each prediction node of the set of prediction nodes representing a binned prediction and ordered with respect to the duration of time;
a set of factor nodes, each factor node representing a factor that has a causal relationship with a binned prediction and ordered with respect to the duration of time; and
a set of edges.

8. The method of claim 7, wherein a first portion of the set of edges represents connections from factor nodes to the prediction nodes, a second portion of the set of edges represents connections between the factor nodes, and a third portion of the set of edges represents connections between the prediction nodes.

9. The method of claim 8, wherein selecting quantifications of the causal temporal relationship between the factor and the binned prediction to obtain weights for the relationships comprises performing a global optimization of weights for each edge of the set of edges.

10. The method of claim 9, wherein the relationships and the weights between factors and binned predictions are provided to the downstream consumer in a report that ranks a quantitative impact of each factor on each binned prediction.

11. A non-transitory machine-readable medium having instructions stored therein, which when executed by a processor, cause the processor to perform operations for managing generation of a causal temporal graph, the operations comprising:
obtaining an analysis report, the analysis report comprising a time series prediction over a duration of time;
obtaining, based on the analysis report, prediction bins, each of the prediction bins indicating a portion of the duration of time;
obtaining, using the analysis report and the prediction bins, a set of binned predictions, each binned prediction of the set of binned predictions comprising one or more predictions of the time series prediction;
for each binned prediction of the binned predictions, identifying at least one factor, using the binned prediction, the analysis report, and a large language model (LLM), which has a causal temporal relationship to the binned prediction;
obtaining, using the set of binned predictions and the at least one factor for each of the binned predictions, the causal temporal graph, the causal temporal graph indicating relationships between the factors and the binned predictions of the set of binned predictions;
selecting, using at least the causal temporal graph and values for the binned predictions, quantifications of the causal temporal relationship between the factor and the binned prediction to obtain weights for the relationships; and
providing the relationships and the weights between the factors and the binned predictions to a downstream consumer for use in interpreting the time series prediction.

12. The non-transitory machine-readable medium of claim 11, wherein the analysis report comprises a set of predictions indicating a condition impacting a business over the duration of time.

13. The non-transitory machine-readable medium of claim 12, wherein the condition impacting the business over the duration of time is a change in demand of a product by consumers.

14. The non-transitory machine-readable medium of claim 12, wherein identifying the factors comprises:
providing the analysis report and the binned predictions as ingest data for the LLM; and
obtaining, as an output from the LLM, the factors and a set of causal relationships.

15. The non-transitory machine-readable medium of claim 14, wherein the set of causal relationships comprises:
a first causal relationship, the first causal relationship indicating that a first factor of the factors impacted generation of at least a first prediction of the set of predictions by an inference model.

16. A data processing system, comprising:
a processor; and
a memory coupled to the processor to store instructions, which when executed by the processor, cause the processor to perform operations for managing generation of a causal temporal graph, the operations comprising:
obtaining an analysis report, the analysis report comprising a time series prediction over a duration of time;
obtaining, based on the analysis report, prediction bins, each of the prediction bins indicating a portion of the duration of time;
obtaining, using the analysis report and the prediction bins, a set of binned predictions, each binned prediction of the set of binned predictions comprising one or more predictions of the time series prediction;
for each binned prediction of the binned predictions, identifying at least one factor, using the binned prediction, the analysis report, and a large language model (LLM), which has a causal temporal relationship to the binned prediction;
obtaining, using the set of binned predictions and the at least one factor for each of the binned predictions, the causal temporal graph, the causal temporal graph indicating relationships between the factors and the binned predictions of the set of binned predictions;
selecting, using at least the causal temporal graph and values for the binned predictions, quantifications of the causal temporal relationship between the factor and the binned prediction to obtain weights for the relationships; and
providing the relationships and the weights between the factors and the binned predictions to a downstream consumer for use in interpreting the time series prediction.

17. The data processing system of claim 16, wherein the analysis report comprises a set of predictions indicating a condition impacting a business over the duration of time.

18. The data processing system of claim 17, wherein the condition impacting the business over the duration of time is a change in demand of a product by consumers.

19. The data processing system of claim 17, wherein identifying the factors comprises:
providing the analysis report and the binned predictions as ingest data for the LLM; and
obtaining, as an output from the LLM, the factors and a set of causal relationships.

20. The data processing system of claim 19, wherein the set of causal relationships comprises:
a first causal relationship, the first causal relationship indicating that a first factor of the factors impacted generation of at least a first prediction of the set of predictions by an inference model.
